(19) United States
(12) Patent Application Publication
(10) Pub. No.: US 2025/0282393 A1
(43) Pub. Date: Sep. 11, 2025

(54) NEGOTIATION OF INTERSECTIONS BY AUTONOMOUS WORK MACHINES USING PERMISSION MANAGEMENT

(71) Applicant: Caterpillar Inc., Peoria, IL (US)

(72) Inventors: Ruchi P. BHATIA, Dunlap, IL (US); Matthew Alan HOLMES, Metamora, IL (US)

(73) Assignee: Caterpillar Inc., Peoria, IL (US)

(21) Appl. No.: 18/596,489

(22) Filed: Mar. 5, 2024

(51) Int. Cl. B60W 60/00; B60P 1/04

(52) U.S. Cl. CPC B60W 60/00272; B60P 1/04; B60W 2300/125; B60W 2756/10

(57) ABSTRACT

Traditionally, a management system, which grants permissions to autonomous work machines for negotiating intersections, will grant permissions in the order in which they are requested. However, this technique can often result in slowdowns and other inefficiencies in operations at the worksite. Accordingly, in disclosed embodiments, the work machines estimate entry and exit times for upcoming intersections, send these estimated times to the management system, and wait for permissions to enter the intersections. The management system determines whether conflicts exist based on the estimated times, and when a conflict exists, prioritizes the work machines involved in the conflict based on one or more factors. Then, the management system grants permissions according to the determined priorities, to thereby optimize the negotiation of intersections within the worksite.

### TECHNICAL FIELD

The embodiments described herein are generally directed to negotiating intersections, and, more particularly, to the negotiation of intersections by autonomous work machines using permission management.

### BACKGROUND

Autonomous work machines, such as haul trucks, at a worksite, such as a mine site, are typically managed by a central site-wide management system. The management system may manage permissions for the autonomous work machines. In particular, the management system may manage a path, through the worksite, that each work machine is permitted to drive to complete a task assigned to the work machine. The management system may divide each path into segments or “sub-paths.” When a work machine approaches the start of a sub-path, the work machine will request permission to proceed along the sub-path. In response to the request, the management system will analyze whether the sub-path is clear or occupied (e.g., either currently occupied or committed to be occupied) by another work machine. When the sub-path is clear, the management system will provide the work machine with permission to proceed along the sub-path. On the other hand, when the sub-path is occupied, the management system will withhold permission until the sub-path is clear. During this time, the work machine may have to stop and wait.

The paths of two work machines may conflict, for example, when both work machines approach the same intersection from different directions. If the work machines request permission at different times, a typical management system will simply grant permission to the work machine that requested permission first, and then, after that work machine has cleared the intersection, grant permission to the work machine that requested permission second. However, this technique does not resolve a conflict when the work machines request permission at the same time.

In addition, this technique can often result in slowdowns and other inefficiencies in operations at the worksite. For example, a first work machine that arrives at the intersection first may be forced to stop and wait for the intersection to be cleared by a second work machine that arrives at the intersection second, just because the second work machine requested permission first. This may be the case even though the first work machine could have cleared the intersection prior to the arrival of the second work machine. These inefficiencies increase dramatically as the number of intersections increases and as the number of autonomous work machines operating in the same time period increases.

There are a number of systems that are designed to manage permissions of autonomous work machines. Examples include the systems described in U.S. Pat. No. 9,672,743, issued on Jun. 6, 2017, U.S. Pat. No. 10,062,287, issued on Aug. 28, 2018, U.S. Patent Pub. No. 2023/0052077, published on Feb. 16, 2023, Japanese Patent Pub. No. 2005-225662, published on Aug. 25, 2005, and Chinese Patent No. 112419703, issued on Nov. 30, 2021. The present disclosure is directed toward overcoming one or more of the problems discovered by the inventors.

### SUMMARY

In an embodiment, a method comprises, by a controller of a mobile work machine: receiving one or more intersection locations, wherein each of the one or more intersection locations indicates a location of an intersection of two or more roads in a worksite; determining that one of the one or more intersection locations is upcoming along a path of the work machine; estimating an entry time at which the work machine will enter the intersection whose location is indicated by the one intersection location; estimating an exit time at which the work machine will exit the intersection whose location is indicated by the one intersection location; sending the estimated entry time and the estimated exit time to an external system via a wireless network; and controlling the work machine to not enter the intersection, whose location is indicated by the one intersection location, until after permission is obtained from the external system.

In an embodiment, a work machine comprises: a machine body; one or more ground-engaging members configured to move the machine body with respect to a ground; and a controller configured to receive one or more intersection locations, wherein each of the one or more intersection locations indicates a location of an intersection of two or more roads in a worksite, determine that one of the one or more intersection locations is on a path of the work machine, estimate an entry time at which the work machine will enter the intersection whose location is indicated by the one intersection location, estimate an exit time at which the work machine will exit the intersection whose location is indicated by the one intersection location, send the estimated entry time and the estimated exit time to an external system via a wireless network, and control the work machine to not enter the intersection, whose location is indicated by the one intersection location, until after permission is obtained from the external system.

In an embodiment, a method comprises, by at least one processor of a management system: receiving estimated entry times and estimated exit times from a plurality of work machines for at least one intersection; determining whether a conflict exists between two or more of the plurality of work machines based on the received estimated entry times and estimated exit times, wherein a conflict exists when the two or more work machines are estimated to be in the at least one intersection at a same time; when no conflict exists, sending permission to each of the two or more work machines; and when the conflict exists, determining priorities for the two or more work machines, and sending permission to each of the two or more work machines according to the determined priorities.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 illustrates control of an autonomous work machine in a machine environment, according to an embodiment;

FIG. 2 illustrates an example processing system, by which one or more of the processes described herein, may be executed, according to an embodiment;

FIG. 3 illustrates a scenario involving autonomous work machines at a worksite, according to an example;

FIG. 4 illustrates a process for negotiating an intersection by an autonomous work machine, according to an embodiment; and

FIG. 5 illustrates a process for managing autonomous work machines, according to an embodiment.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details.

In some instances, well-known structures and components are shown in simplified form for brevity of description. For clarity and ease of explanation, some surfaces and details may be omitted in the present description and figures. It should also be understood that the various components illustrated herein are not necessarily drawn to scale. In other words, the features disclosed in various embodiments may be implemented using different relative dimensions within and between components than those illustrated in the drawings.

As used herein, a reference numeral with an appended letter will be used to refer to a specific component, whereas the same reference numeral without any appended letter will be used to refer collectively to a plurality of the component or to refer to a generic or arbitrary instance of the component. In addition, the terms “respective” and “respectively” signify an association between members of a group of first items and members of a group of second items. For example, the phrase “each component A connected to a respective component B” would signify A1 connected to B1, A2 connected to B2, and so on and so forth, up to AN connected to BN.

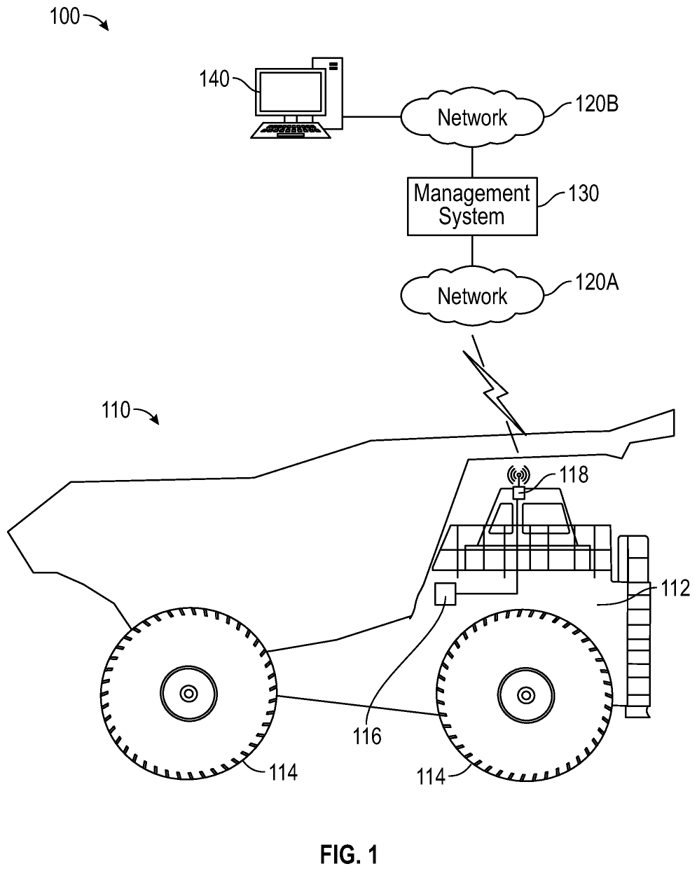

FIG. 1 illustrates control of an autonomous work machine 110 in a machine environment 100, according to an embodiment. Machine environment 100 may include an environment, including a worksite, in which one or more autonomous work machines 110 perform tasks associated within an industry, such as mining, construction, forestry, transportation, energy exploration, farming, or the like. For example, machine environment 100 could include a mining site in which a plurality of work machines 110 cooperate to perform a task associated with mining. However, it should be understood that disclosed embodiments are not limited to any particular environment. In addition, while work machine 110 is illustrated as a haul truck, it should be understood that work machine 110 may be any type of mobile equipment, including a wheel loader, dump truck, asphalt paver, backhoe loader, skid steer, track loader, cold planer, compactor, bulldozer, electric rope shovel, forest machine, hydraulic mining shovel, material handler, motor grader, pipe-layer, road reclaimer, telehandler, tractor-scraper, or the like, as well as ordinary road vehicles (e.g., automobiles, semi-trucks, etc.), aircraft, or maritime vessels (e.g., boats, ships, barges, etc.).

In the illustrated example, work machine 110 comprises a machine body 112 and one or more ground-engaging members 114, configured to move machine body 112 with respect to the ground. Machine body 112 may comprise a cabin, an internal combustion engine or electric motor (e.g., driven by a battery pack), and/or the like. The cabin may comprise a seat for an operator, controls (e.g., one or more joysticks, a console comprising an integrated display with inputs, etc.), and/or the like. Ground-engaging members 114 are illustrated as wheels, but may comprise other types of components for moving machine body 112 with respect to the ground, such as tracks, rollers, and/or the like. Ground-engaging members 114 may be driven by a drivetrain, which is in turn driven by an internal combustion engine or electric motor.

Work machine 110 may comprise a controller 116, which may be an electronic control unit (ECU). Controller 116 may be communicatively coupled (e.g., via wired or wireless communications) to one or a plurality of sensors and/or one or a plurality of subsystems of work machine 110. Controller 116 may collect data from the sensor(s) and/or subsystem(s) of work machine 110 and process the collected data. Processing the collected data may comprise determining one or more machine states from the collected data, generating an alert based on the collected data (e.g., if a value of a parameter in the data satisfies a predefined threshold), filtering, analyzing, sorting, correlating, storing, and/or relaying the collected data, and/or the like. Controller 116 may also control the operation of one or more subsystems of work machine 110 based on the collected data and/or local or remote control commands. For example, controller 116 may be communicatively coupled to a fuel injection system associated with the engine of work machine 110. Controller 116 may receive a control command (e.g., increase throttle) and provide command signals to the fuel injection system, which may responsively increase the flow of fuel from a fuel supply to the engine. The engine may be connected to a torque converter that transmits power from the engine to a transmission of the drivetrain that drives ground-engaging members 114, to thereby move work machine 110 with respect to the ground.

The sensor(s) may include any type of sensor or sensor array capable of measuring values of one or more parameters of one or more subsystems of work machine 110 and/or machine environment 100. Examples of such parameters include, without limitation, the position of work implements, engine speed, machine speed, pressure of a fluid (e.g., fuel, oil, coolant, hydraulic fluid, etc.), flow rate of a fluid, temperature of a fluid, contamination level of a fluid, viscosity of a fluid, electric current, electric voltage, state of charge of a battery pack, fluid consumption rates, loading level, transmission output ratio, slip, grade, traction, mileage, time or mileage until or since scheduled maintenance, and/or the like. In an embodiment, the sensor(s) include a receiver of a Global Navigation Satellite System (GNSS), such as the Global Positioning System (GPS), which can be utilized to determine a location (e.g., in GPS coordinates) of work machine 110. The sensor(s) may also include one or more cameras (e.g., regular or stereo cameras), radar systems (e.g., a Light Detecting and Ranging (LiDAR) system), and/or the like, to aid in the navigation of machine environment 100 (e.g., by providing computer vision).

Work machine 110 may comprise a communication module 118, which may be separate or integral to controller 116. Communication module 118 may comprise hardware and/or software that enables communication between communication module 118 and an access point of a network 120A, which may comprise or consist of a wireless network. For example, communication module 118 may comprise or be connected to a processor, network interface, and wireless transceiver with an antenna that enables wireless communication with the base station of a cellular network. Communication module 118 may send data to a management system 130 and/or receive data from management system 130 via network 120A. For instance, controller 116 may transmit any of the data, that are collected (e.g., from sensor(s) in work machine 110) or derived from collected data, to management system 130 via communication module 118, as well as receive data, such as control commands, from management system 130 via communication module 118.

Management system 130 is one example of an external system that may host and/or execute one or more of the various functions, processes, methods, and/or software modules described herein. Management system 130 may comprise dedicated servers or may instead be implemented in a computing cloud, in which the resources of one or more servers are dynamically and elastically allocated to multiple tenants based on demand. These servers may be collocated (e.g., in a single data center) and/or geographically distributed (e.g., across multiple data centers). Management system 130 may be communicatively connected to work machine 110 via network 120A and/or a remote terminal 140 via network 120B. Networks 120A and 120B (which may be collectively referred to herein as network 120) may be the same network, separate and distinct networks, or overlapping networks, and may include one or more cellular networks, one or more satellite networks, the Internet, one or more intranets, and/or the like. While only a single instance of work machine 110 and a single instance of remote terminal 140 are illustrated, it should be understood that management system 130 may be communicatively coupled to any number of work machines 110 and remote terminals 140.

Management system 130 may comprise one or more web servers which host one or more websites and/or web services. In embodiments in which a website is provided, the website may comprise a graphical user interface, including, for example, one or more screens (e.g., webpages) generated in HyperText Markup Language (HTML) or other language. Management system 130 transmits or serves one or more screens of the graphical user interface in response to requests from remote terminal 140 via network 120B. These screens may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and/or the like.

In embodiments in which a web service is provided, management system 130 may receive requests from external systems, and provide responses in eXtensible Markup Language (XML), JavaScript Object Notation (JSON), and/or any other suitable or desired format. In such embodiments, management system 130 may provide an application programming interface (API) (e.g., implemented with a Representation State Transfer (REST) architecture) which defines the manner in which work machine 110, remote terminal 140, and/or other external system(s) may interact with the web service. Thus, work machine 110, remote terminal 140, and/or other external systems (which may themselves be servers), can define their own user interfaces, and rely on the web service to implement or otherwise provide the backend processes, methods, functionality, storage, and/or the like, described herein. For example, in such an embodiment, a client application, executing on remote terminal 140, may interact with management system 130 to execute one or more or a portion of one or more of the various functions, processes, methods, and/or software modules described herein. In this case, the client application may generate the graphical user interface and access functionality on management system 130 via the API.

Remote terminal 140 may comprise any type of computing device capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that remote terminal 140 is a professional workstation by which a site manager or other user may access management system 130. For example, the user may sign in to management system 130 (e.g., using any standard authentication means, such as a username and password) to view data about the worksite, work machines 110, and/or the like, including schedules of work machines 110, locations and/or statuses of work machines 110, assigned tasks and/or paths of work machines 110, measured parameters (e.g., sensor outputs) of work machines 110, and/or the like.

Management system 130 may operate work machines 110 autonomously, without any human operator, or semi-autonomously, with limited intervention by a human operator. During autonomous operation, management system 130 may receive data from work machines 110, generate and send tasks for work machines 110 to complete, including assigned paths for work machines 110 to follow, generate and send control commands to work machines 110, and/or the like. Controller 116 of each work machine 110 may send data, receive the tasks, receive the control commands, and/or the like, from management system 130, and operate work machine 110 autonomously, based on the received information.

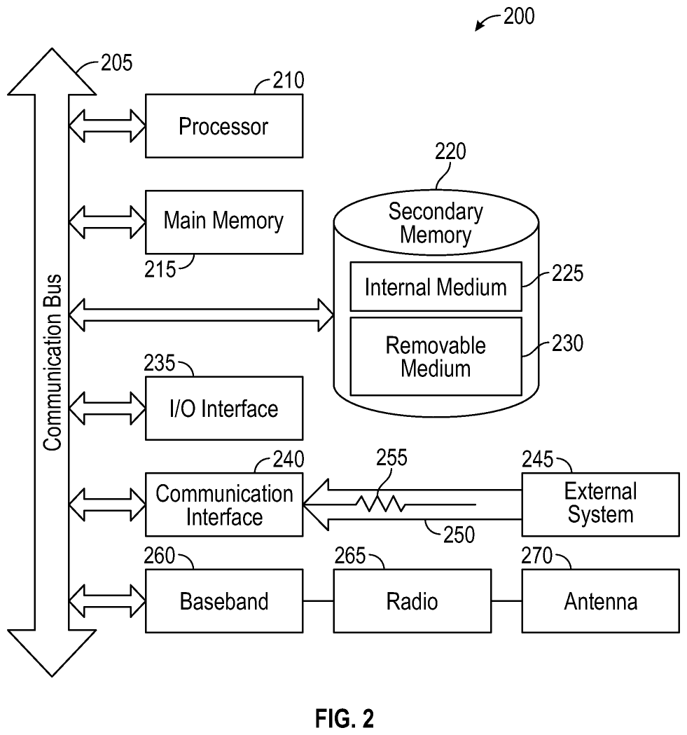

FIG. 2 illustrates an example processing system 200, by which one or more of the processes described herein, may be executed, according to an embodiment. System 200 may be a wired or wireless system that is used in connection with any of the various embodiments described herein. For example, system 200 may be used as or in conjunction with one or more of the functions, processes, or methods described herein (e.g., to store and/or execute the implementing software), and may represent components of work machine 110 (e.g., controller 116, communication module 118, camera(s) or other sensors, etc.), management system 130, remote terminal 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, any of the processors (e.g., Pentium™, Core i7™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE), and/or the like.

System 200 preferably includes a main memory 215 and may also include a secondary memory 220. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 is a non-transitory computer-readable medium having computer-executable code (e.g., any of the software disclosed herein) and/or other data stored thereon. The computer software or data stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), flash memory (block-oriented memory similar to EEPROM), and the like.

In an embodiment, I/O interface 235 provides an interface between one or more components of system 200 and one or more input and/or output devices. Example input devices include, without limitation, sensors, keyboards, touch screens or other touch-sensitive devices, joysticks, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., display console, smartphone, tablet computer, mobile device, etc.).

System 200 may include a communication interface 240. Communication interface 240 allows software and data to be transferred between system 200 and an external system 245. For example, computer software or executable code may be transferred to system 200 from a network server (e.g., management system 130) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

System 200 may also include wireless communication components that facilitate wireless communication over a voice network and/or a data network. The wireless communication components, which may correspond to communication module 118 in the event that system 200 implements controller 116, may comprise an antenna 270, a radio 265, and a baseband 260. Baseband 260 is communicatively coupled with processor(s) 210. In system 200, RF signals are transmitted and received over the air by antenna 270 under the management of radio 265.

Computer-executable code (e.g., computer programs, such as the disclosed software) is stored in main memory 215 and/or secondary memory 220. Computer-executable code can also be received via communication interface 240 and/or communication module 118 (e.g., comprising baseband 260, radio 265, and antenna 270) and stored in main memory 215 and/or secondary memory 220. Such computer programs, when executed, may enable system 200 to perform the various functions of the disclosed embodiments described elsewhere herein.

In this description, the term “computer-readable medium” is used to refer to any non-transitory computer-readable storage media used to provide computer-executable code and/or other data to or within system 200. Examples of such media include main memory 215, secondary memory 220, external system 245, and any peripheral device communicatively coupled with communication interface 240 (including a network information server or other network device). These non-transitory computer-readable media are means for providing software and/or other data for utilization in system 200.

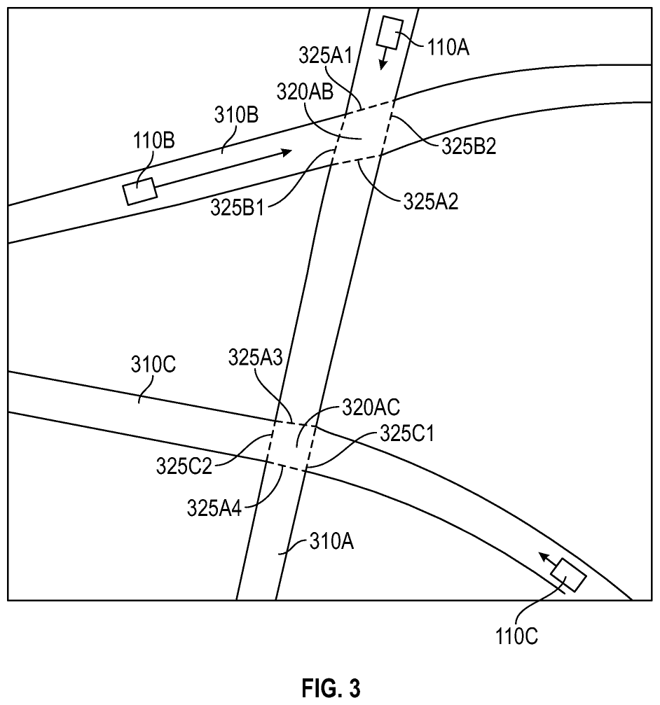

FIG. 3 illustrates a scenario involving autonomous work machines 110 at a worksite, according to an example that will be used to described embodiments. In the illustrated scenario, the worksite comprises a plurality of roads 310, illustrated as roads 310A, 310B, and 310C, with a plurality of intersections 320, illustrated as intersection 320AB of roads 310A and 310B and intersection 320AC of roads 310A and 310C. A plurality of work machines 110, illustrated as work machines 110A, 110B, and 110C, are operational within the worksite during the same time period.

In this scenario, work machine 110A is on a path along road 310A, and work machine 110B is on a path along road 310B. Work machines 110A and 110B are simultaneously approaching intersection 320AB. Work machine 110A is closest to intersection 320AB and requests permission to cross intersection 320AB before work machine 110B. However, work machine 110B is traveling at a much higher speed than work machine 110A, such that work machine 110B will reach intersection 320AB before work machine 110A. For ease of description, it will be assumed that the paths of work machine 110A and work machine 110B are both straight through intersection 320AB. However, it should be understood that one or both of the paths could alternatively turn left or right at intersection 320AB.

Traditionally, the work machine 110 that first requested permission to cross intersection 320AB would receive permission to cross intersection 320AB first. Thus, in this case, traditionally, work machine 110A would receive permission to cross intersection 320AB before work machine 110B. This would require work machine 110B, which reaches intersection 320AB before work machine 110A, to decelerate and stop at boundary 325B1 of intersection 320AB, wait for work machine 110A to clear intersection 320AB, and then accelerate and proceed through intersection 320AB. However, this is inefficient, since work machine 110B could have cleared intersection 320AB before work machine 110A reached intersection 320AB, such that no work machine 110 needed to stop. In other words, the time required for work machine 110B to decelerate to a stop, wait, and accelerate from the stop represents an unnecessary slowdown.

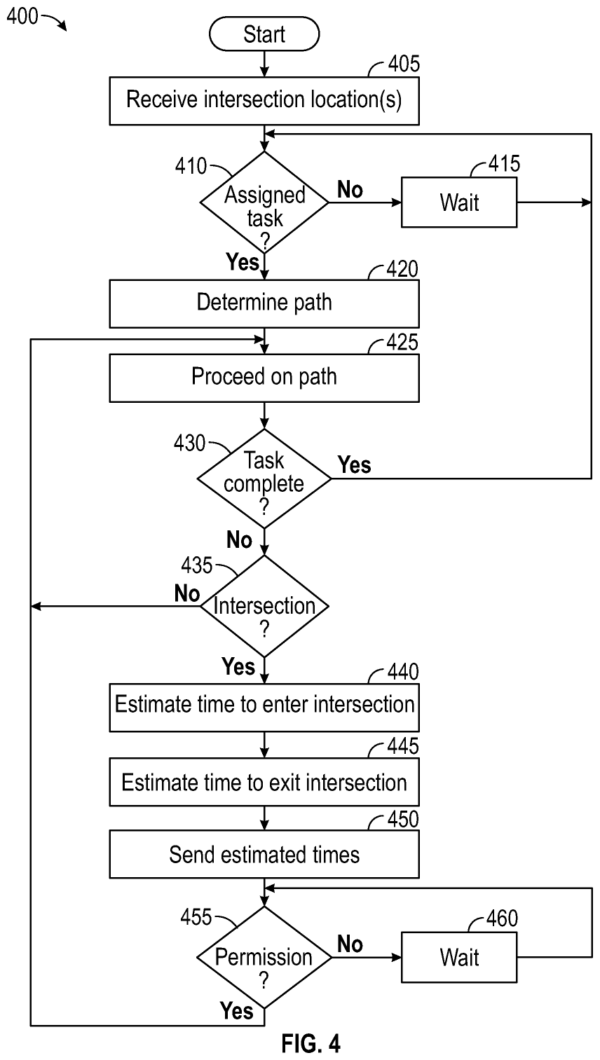

FIG. 4 illustrates a process 400 for negotiating an intersection 320 by an autonomous work machine 110, according to an embodiment. Process 400 may be implemented in software and/or hardware by controller 116 (e.g., as embodied in a system 200). Process 400 may execute continuously for as long as work machine 110 is operational, and end, along with other functions of work machine 110, when work machine 110 is shutdown (i.e., operation of work machine 110 is terminated). While process 400 is illustrated with a certain arrangement and ordering of subprocesses, process 400 may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

In subprocess 405, controller 116 receives one or more, and generally a plurality of, intersection locations. Each intersection location indicates the location of an intersection 320 of two or more roads 310 in the worksite. In an embodiment, controller 116 receives these intersection location(s) from management system 130, via communication module 118 and network 120A. The locations of roads 310 and/or intersections 320 may change, and/or roads 310 and/or intersections 320 may be added or removed, in some worksites, such as mining sites. Accordingly, management system 130 may periodically send the intersection location(s) to controller 116 of each work machine 110 according to a fixed time interval, whenever there is a change to an intersection location, whenever a new intersection location is added, whenever an existing intersection is removed, and/or the like. Additionally or alternatively, management system 130 may send the intersection location(s) to a work machine 110 in response to a request from that work machine 110. Whenever controller 116 receives intersection location(s) from management system 130, controller 116 may store and/or update the intersection location(s) in persistent memory, such as secondary memory 220.

In an embodiment, the intersection location(s) may be provided in the form of a representation (e.g., map) of the worksite, with the location of each intersection 320 in the representation of the worksite tagged by a marker that identifies the intersection 320 (e.g., using a unique identifier of intersection 320). More generally, each landmark in the worksite may be tagged with a marker that identifies the landmark (e.g., using a unique identifier of the landmark). Of particular relevance to disclosed embodiments, the landmarks comprise one or more intersections 320. Examples of other types of landmarks, include, without limitation, bridges, bends in a road 310, waiting (e.g., parking) areas, loading areas, dumping areas, fueling or charging stations, and/or the like. Landmarks may also include the end of fixed distance intervals, such as mile markers. In the illustrated scenario, management system 130 may send, to each of work machines 110A, 110B, and 110C, a representation of the worksite with at least the locations of intersection 320AB and intersection 320AC tagged by a marker identifying the respective intersection.

In subprocess 410, controller 116 determines whether or not a task has been assigned to work machine 110. In an embodiment, work machine 110 is assigned tasks by management system 130. In particular, management system 130 may optimize production at the worksite by managing the tasks performed by each work machine 110. When management system 130 assigns a new task to a work machine 110, management system 130 may send the assigned task to the work machine 110 via network 120A. Work machine 110 may receive the assigned task, which may include a path along one or more roads 310 and through one or more intersections 320 within the worksite, and begin operation according to the assigned task. When work machine 110 has no assigned task (i.e., “No” in subprocess 410), process 400 may proceed to subprocess 415. Otherwise, when work machine 110 has an assigned task (i.e., “Yes” in subprocess 410), process 400 may proceed to subprocess 420.

In subprocess 415, controller 116 may wait for a new task. In particular, controller 116 may retain work machine 110 in, or switch work machine 110 to, a waiting mode. In the waiting mode, controller 116 may control work machine 110 to stop where it is and wait for a task, travel to a waiting area where it can stop and wait for a task (e.g., a parking area that is out of the way of other work machines 110), travel to a fueling station to be refueled or to a charging station to be charged, perform one or more default tasks, or the like.

In subprocess 420, controller 116 may determine the path for the assigned task. The path may be provided by management system 130 (e.g., when sending the task). Alternatively, controller 116 may determine the path based on information provided for the assigned task by management system 130. As mentioned above, the path may be divided into sub-paths, and controller 116 may request permission to proceed along each sub-path in advance of reaching the start of each sub-path. However, disclosed embodiments are directed to the negotiation of intersections. Accordingly, for the sake of simplicity, other aspects of permission management will be omitted from the present disclosure. It should be understood that the disclosed embodiments may be utilized within a larger permission-management architecture.

In the illustrated scenario, each of work machines 110A, 110B, and 110C have already been assigned respective tasks. Each work machine 110 has already determined a respective path. In particular, the path of work machine 110A comprises a straight sub-path along road 310A and through intersections 320AB and 320AC, the path of work machine 110B comprises a straight sub-path along road 310B and through intersection 320AB, and the path of work machine 110C comprises a straight sub-path along road 310C and through intersection 320AC.

In subprocess 425, controller 116 may control work machine 110 to proceed along the path that was determined in subprocess 420. In particular, controller 116 may control the engine (e.g., internal combustion engine, electric motor, etc.) and steering system of work machine 110 to drive autonomously along a road 310, according to the determined path. In the illustrated scenario, controller 116 of work machine 110A controls work machine 110A to drive along road 310A towards intersection 320AB, controller 116 of work machine 110B controls work machine 110B to drive along road 310B towards intersection 320AB, and controller 116 of work machine 110C controls work machine 110C to drive along road 310C towards intersection 320AC.

In subprocess 430, controller 116 may determine whether or not the assigned task is complete. The assigned task may be determined to be complete when work machine 110 has reached a final destination along the path determined in subprocess 420, and potentially performed some action at the final destination (e.g., a loading or unloading action). When determining that the assigned task is not complete (i.e., “No” in subprocess 430), process 400 may proceed to subprocess 435. Otherwise, when determining that the assigned task is complete (i.e., “Yes” in subprocess 430), process 400 may return to subprocess 410 to await a new task.

In subprocess 435, controller 116 may determine whether or not work machine 110 is approaching an intersection 320. In particular, controller 116 may continually monitor the current location of work machine 110 (e.g., using a GPS receiver) and the locations of tagged landmarks, including intersections 320, that are upcoming along the path that was determined in subprocess 420. When determining that an intersection location is upcoming along the path of work machine 110 (i.e., “Yes” in subprocess 435), process 400 may proceed to subprocess 440. Otherwise, when determining that no intersection location is upcoming along the path of work machine 110 (i.e., “No” in subprocess 435), process 400 may return to subprocess 425, such that work machine 110 continues along the path.

In subprocess 435, controller 116 of work machine 110 may determine either only the next intersection 320 along the path, all intersections 320 that remain along the path, or up to a predefined number of consecutive next intersections 320 along the path. In the illustrated scenario, controllers 116 of work machine 110A and work machine 110B both determine that intersection 320AB is upcoming, and controller 116 of work machine 110C determines that intersection 320AC is upcoming. In addition, controller 116 of work machine 110A may also determine that intersection 320AC is upcoming after intersection 320AB.

In subprocess 440, controller 116 may estimate an entry time at which work machine 110 will enter the intersection 325 whose location is indicated by each intersection location determined to be upcoming along the path of work machine 110. Each entry time may be estimated by calculating a time (e.g., an absolute time, time duration from the current time, or the like), at which work machine 110 will arrive at the start of intersection 325, based on the current speed of work machine 110, the current distance between work machine 110 and the start of intersection 325, the machine profile of work machine 110, the geometry of road 310 (e.g., uphill vs. downhill, straight vs. curved, etc.), the state of work machine 110 (e.g., with or without payload), the presence of any obstacles (e.g., determined by computer-vision, using cameras or other sensors, onboard work machine 110), and/or the like.

In the illustrated scenario, controller 116 of work machine 110A estimates the time at which work machine 110A will arrive at a first boundary 325A1 of intersection 320AB, controller 116 of work machine 110B estimates the time at which work machine 110B will arrive at a first boundary 325B1 of intersection 320AB, and controller 116 of work machine 110C estimates the time at which work machine 110C will arrive at a first boundary 325C1 of intersection 320AC. In addition, controller 116 of work machine 110A may estimate the time at which work machine 110A will arrive at a first boundary 325A3 of intersection 320AC.

In subprocess 445, controller 116 may estimate an exit time at which work machine 110 will exit the intersection 325 whose location is indicated by each intersection location determined to be upcoming along the path of work machine 110. Each exit time may be estimated by calculating a time (e.g., an absolute time, time duration from the current time, or the like), at which work machine 110 will clear the end of intersection 325, based on the current speed of work machine 110, the current distance between work machine 110 and the end of intersection 325, the machine profile of work machine 110 (e.g., including the length of work machine 110), the geometry of road 310 (e.g., uphill vs. downhill, straight vs. curved, etc.), the state of work machine 110 (e.g., with or without payload), the presence of any obstacles (e.g., determined by computer-vision, using cameras or other sensors, onboard work machine 110), and/or the like.

In the illustrated scenario, controller 116 of work machine 110A estimates the time at which work machine 110A will clear a second boundary 325A2 of intersection 320AB, controller 116 of work machine 110B estimates the time at which work machine 110B will clear a second boundary 325B2 of intersection 320AB, and controller 116 of work machine 110C estimates the time at which work machine 110C will clear a second boundary 325C2 of intersection 320AC. In addition, controller 116 of work machine 110A may estimate the time at which work machine 110A will clear a second boundary 325A4 of intersection 320AC. It should be understood that embodiments will work just as well for paths that turn through an intersection 320. For example, if the path of work machine 110A includes a left turn through intersection 320AB, instead of a straight sub-path through intersection 320AB, controller 116 of work machine 110A would estimate the time at which work machine 110A will clear second boundary 325B2, instead of second boundary 325A2.

In subprocess 450, controller 116 may send the entry time, estimated in subprocess 440, and the exit time, estimated in subprocess 445, to management system 130, via communication module 118 and network 120A. Management system 130 may receive the estimated entry and exit times for a plurality of work machines 110, operating at the worksite, and determine the optimal order of permissions for work machines 110 to cross intersections 325. Then, management system 130 may send permissions to work machines 110, over network 120A, in the optimal order. For each intersection 320, after management system 130 has sent a permission to one work machine 110, management system 130 may wait until that work machine 110 clears intersection 320 before granting any subsequent permission. The operation of management system 130 is described in greater detail elsewhere herein.

In subprocess 455, controller 116 determines whether or not permission to cross intersection 320 has been received. Permission may be received from management system 130, via communication module 118 and network 120A. When permission to cross intersection 320 is received (i.e., “Yes” in subprocess 455), process 400 may return to subprocess 425, such that work machine 110 continues along the path. Otherwise, when no permission to cross intersection 320 has been received (i.e., “No” in subprocess 455), process 400 may proceed to subprocess 460.

In subprocess 460, controller 116 may wait until permission to cross intersection 325 is received. In particular, controller 116 may retain work machine 110 in, or switch work machine 110 to, a waiting mode. In the waiting mode, controller 116 may control work machine 110 (e.g., an engine and/or braking system of work machine 110) to reduce the speed of work machine 110, potentially to a full stop, in advance of intersection 325. In some cases, it may not be necessary for work machine 110 to come to a full stop, for example, when permission is received in subprocess 455 before work machine 110 has come to a full stop. In any case, controller 116 controls work machine 110 to not enter intersection 320 until after permission is obtained from management system 130.

In an embodiment, controller 116 may minimize stopping, to thereby reduce fuel or battery consumption. When a work machine 110 is forced to decelerate to a full stop, wait, and then accelerate to speed again, substantial fuel or battery charge is consumed. Thus, in an embodiment, as work machine 110 approaches an intersection 320 while having not yet received permission to enter intersection 320, controller 116 may reduce the speed of work machine 110 with a goal of not reaching intersection 320 before permission has been received, to thereby prevent the need to stop at intersection 320, and thereby reduce fuel or battery consumption. Controller 116 may reduce the speed of work machine 110 based on the distance between the current location of work machine 110 and the location of intersection 320, an estimated time at which work machine 110 will receive permission to cross intersection 320, and/or the like. The time at which work machine 110 will receive permission to cross intersection 320 may be provided by management system 120 over network 120A.

Management system 120 may determine the estimated time at which each work machine 110 will receive permission to cross intersection 320, based on the estimated exit times received for each work machine 110 with respect to intersection 320. As will be discussed elsewhere herein, management system 120 may prioritize work machines 110 when a conflict exists for an intersection 320. Management system 120 may determine the estimated time at which each work machine 110 will receive permission to cross intersection 320 based on the estimated exit times for each work machine 110 having higher priority than that work machine 110.

In the illustrated scenario, in subprocess 450, controller 116 of each work machine 110A, 110B, and 110C may send the estimated entry and exit times to management system 130 over network 120A via their respective communication modules 118. Management system 130 may determine that work machine 110B can cross intersection 320AB before work machine 110A even reaches intersection 320AB. Thus, management system may firstly grant permission to work machine 110B to cross intersection 320AB (e.g., received in subprocess 455 by controller 116 of work machine 110B), and then, once work machine 110B has cleared intersection 320AB, secondly grant permission to work machine 110A to cross intersection 320AB (e.g., received in subprocess 455 by controller 116 of work machine 110A). In this case, neither work machine 110A nor 110B may have to decelerate or stop. However, if the estimated times turn out to be incorrect (e.g., because work machine 110A and/or 110B changes speed, noise in the estimates, etc.), such that work machine 110A reaches intersection 320AB before work machine 110B has entered or cleared intersection 320AB, work machine 110A will stop and wait before crossing boundary 325A1, since it will not yet have received permission. Thus, safety is maintained. It should be understood that work machines 110A and 110C may negotiate intersection 320AC in the same manner.

In an embodiment that minimizes stopping, controller 116 of work machine 110A may determine that it will not receive permission before it reaches intersection 320AB at its current speed. For example, the estimated exit time for work machine 110B may precede the estimated entry time for work machine 110A. In this case, management system 130 may communicate the estimated time, at which work machine 110A will be granted permission to cross intersection 320AB, to controller 116 via network 120A. In response, controller 116 may reduce the speed of work machine 110A, such that the estimated entry time of work machine 110A, at first boundary 325A1 of intersection 320AB, is at or after work machine 110B has cleared intersection 320AB. This prevents the need for work machine 110A to have to stop at intersection 320AB. After work machine 110B has cleared intersection 320AB, controller 116 may return work machine 110A to its previous speed. This temporary reduction in speed may also resolve any conflict between work machine 110A and work machine 110C at intersection 320AC. Otherwise, controllers 116 of work machine 110A and/or work machine 110C may perform the same technique for intersection 320AC, to thereby prevent any need for work machine 110A or 110C to stop.

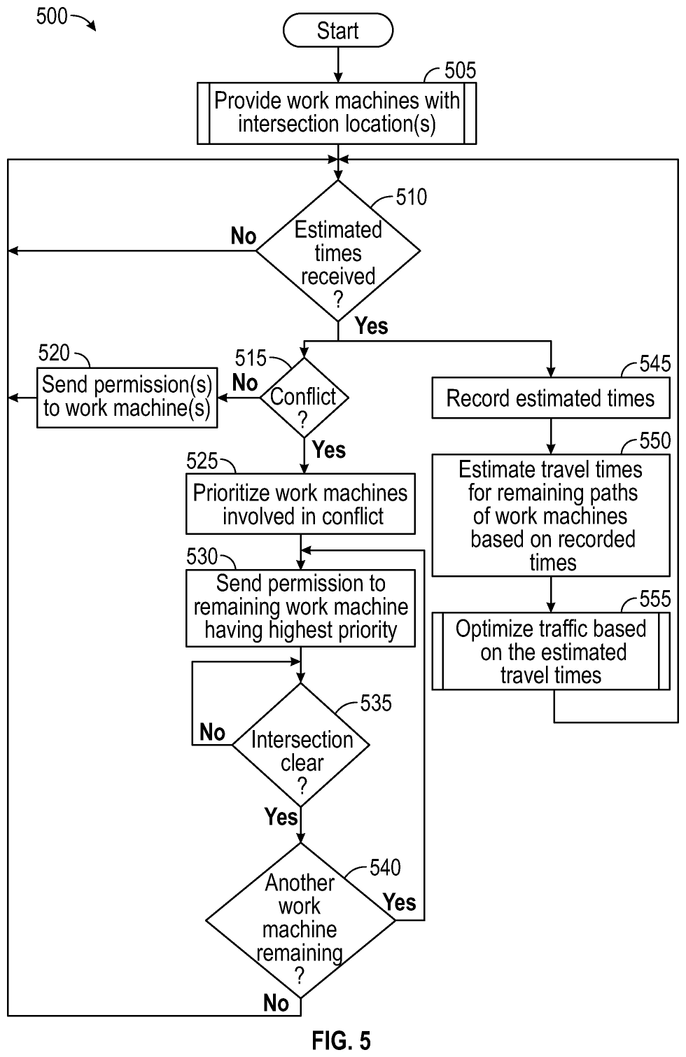

FIG. 5 illustrates a process 500 for managing autonomous work machines 110, according to an embodiment. Process 500 may be implemented in software and/or hardware by management system 130 (e.g., as embodied in a system 200). While process 500 is illustrated with a certain arrangement and ordering of subprocesses, process 500 may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

In subprocess 505, management system 130 provides each work machine 110 with one or more, and generally a plurality of, intersection locations in the worksite. Management system 130 may periodically send the intersection location(s) to each work machine 110 according to a fixed time interval, whenever there is a change to an intersection location, whenever a new intersection location is added, whenever an existing intersection is removed, and/or the like. Additionally or alternatively, management system 130 may send the intersection location(s) to a work machine 110 in response to a request from that work machine 110. As discussed elsewhere herein, the intersection location(s) may be sent as tagged landmarks in a representation (e.g., map) of the worksite.

In subprocess 510, management system 130 determines whether or not any estimated times have been received from work machine(s) 110. In particular, management system 130 may receive estimated entry times and estimated exit times from each of one or more work machines 110. Of particular relevance to disclosed embodiments, management system 130 may receive estimated entry times and estimated exit times from a plurality of work machines 110 for each of one or more intersections 320. When estimated times are received (i.e., “Yes” in subprocess 510), process 500 may proceed to subprocesses 515 and/or 545. Otherwise, when estimated times are not received (i.e., “No” in subprocess 510), process 500 may continue to wait for new estimated times to be received.

Subprocesses 515 and 545 represent entry points to discrete, parallel processes within process 500. The first discrete process, comprising subprocesses 515-540, identifies and resolves conflicts, if any, between work machines 110 at intersections 320. The second discrete process, comprising subprocesses 545-555, optimizes traffic within the worksite. The estimated entry and exit times from work machines 110 for intersection(s) 320 may be used as input to both of these discrete processes. In addition, the second discrete process may utilize other times, estimated by and received from work machines 110, such as the estimated arrival time of a work machine 110 at another type of landmark.

In subprocess 515, management system 130 may determine whether or not a conflict exists. between two or more work machines 110 based on the received estimated entry times and estimated exit times. A conflict exists when two or more work machines 110 are estimated to be in an intersection 320 at the same time. In particular, a time period in which each work machine 110 is estimated to be in each of one or more intersections 320 may be determined based on the estimated entry and exit times for that work machine 110. For example, if the estimated times represent absolute times, the time period that work machine 110 is estimated to be in an intersection 320 is the time period beginning with the estimated entry time and ending with the estimated exit time. A conflict exists if the time periods, in which two or more work machines 110 are estimated to be in the same intersection 320, overlap. A buffer may be incorporated into the overlap (e.g., by adding a buffer period to the start and/or end of each time period) to provide for error tolerance in the estimations and ensure that each work machine 110 is fully clear of an intersection 320 before granting permission to another work machine 110. When no conflict exists (i.e., “No” in subprocess 515), process 500 may proceed to subprocess 520. Otherwise, when a conflict exists (i.e., “Yes” in subprocess 515), process 500 may proceed to subprocess 525.

In subprocess 520, a permission is sent to each of the two or more work machines 110. In particular, management system 130 may send permissions to work machines 110 over network 120A. Notably, when there is no conflict, the order in which the permissions are sent may not matter. Thus, management system 130 may send the permissions serially in any order or in parallel. In any case, work machines 110 will proceed along their respective paths, including through intersection(s) 320.

In subprocess 525, management system 130 may prioritize the work machines 110 involved in the conflict that was identified in subprocess 515. Management system 130 may determine the priorities of the work machines 100, involved in the conflict, based on one or more factors. For example, management system 130 may calculate a value of the task to which each of work machines 110 is assigned based on one or more parameters (e.g., weighted parameters), and prioritize work machines 110, relative to each other, based on the calculated values. The value of the task assigned to a work machine 110 may represent the cost of delaying that work machine 110 from completing its task. In this case, work machines 110 whose tasks have a higher value or cost should be prioritized over work machines 110 whose tasks have a lower value or cost. The one or more parameters may comprise, for example, for each of work machines 110, at least one of a cost of a final destination of the path of work machine 110, an estimated arrival time of work machine 110 at the final destination of the path, an indication of whether or not work machine 110 is hauling a load, an estimated time duration that work machine 110 will have to wait to enter intersection 320, a fuel level or state of charge of work machine 110, and/or the like.

After determining the priorities of work machines 110, permissions may be sent to each of the two or more work machines 110, involved in the conflict, according to the determined priorities. In particular, an iteration of subprocesses 530-540 may be performed until all of the work machines 110, involved in the conflict, have been sent permissions. At a high level, in each iteration, permission is sent to the remaining work machine 110 with the highest priority, and when another work machine 110 remains to receive permission, management system 130 waits until the most recent work machine 110 to receive permission has cleared intersection 320 before sending another permission.

In subprocess 530, management system 130 may send a permission to the one of the remaining work machine(s) 110 having the highest priority, according to the priorities that were determined in subprocess 525. It should be understood that the remaining work machine(s) 110 are those that are involved in the conflict and have not yet been sent permission. To track which work machines 110 have not yet been sent permission, representations of work machines 110, involved in the conflict, may be ordered according to the priorities of work machines 110, and queued such that the work machine 110 with the highest priority is at the front of the queue and the work machine 110 with the lowest priority is at the back of the queue. Then, in each iteration of subprocess 530, the representation of work machine 110 at the front of the queue is removed and the respective work machine 110 is sent a permission to cross intersection 320.

It is possible that, during the described negotiation process, a new work machine 110 could approach the intersection and report its respective estimated entry and exit times. If the new work machine 110 is in conflict with the remaining work machine(s) 110, as determined by the estimated entry and exit times reported by the new work machine 110, the new work machine 110 can be added to the queue of work machine(s) 110. In this case, the priorities of the remaining work machines 110, including the newly added work machine 110, may be redetermined in subprocess 525, and the queue may be reordered in subprocess 530 according to the redetermined priorities.

In subprocess 535, management system 130 may determine whether or not intersection 320 is clear. Intersection 320 may be determined to be clear when the work machine 110, which received permission in the most recent iteration of subprocess 530, has fully crossed the boundary representing the end of intersection 320 along the path of that work machine 110. In an embodiment, a buffer period may be added to ensure that work machine 110 is fully clear of intersection 320. Controller 116 of each work machine 110 may notify management system 130, over network 120A, when work machine 110 has cleared intersection 320, and management system 130 may determine that intersection 320 is clear when the notification is received from the most recent work machine 110 to be sent permission. When determining that intersection 320 is clear (i.e., “Yes” in subprocess 535), process 500 may proceed to subprocess 540. Otherwise, when determining that intersection 320 is not clear (i.e., “No” in subprocess 535), process 500 may continue to wait for work machine 110 to clear intersection 320.

In subprocess 540, management system 130 determines whether or not another work machine 110, involved in the conflict, remains to be considered. In an embodiment in which a queue is used, it may be determined that a work machine 110 remains to be considered when the queue is not empty, and determined that no work machine 110 remains to be considered when the queue is empty. When determining that a work machine 110 remains to be considered (i.e., “Yes” in subprocess 540), process 500 may return to subprocess 530 to consider the next work machine 110, according to the determined priorities. Otherwise, when determining that no work machine 110 remains to be considered (i.e., “No” in subprocess 540), process 500 may return to subprocess 510.

In subprocess 545, management system 130 may record the estimated times that were received in subprocess 510. For example, management system 130 may store the estimated entry times and estimated exit times, from potentially a plurality of work machines 110 and for potentially a plurality of intersections 320, in persistent memory (e.g., secondary memory 220) of management system 130. Management system 130 may also record other estimated times, such as estimated arrival times of work machines 110 at other types of landmarks. This record represents an estimated schedule of traffic within the worksite for at least a portion of the paths of work machines 110. Management system 130 may also receive and store the states of work machines 110, such that the record also represents the state of each work machine 110.

In subprocess 550, management system 130 may estimate travel times for the remaining portions of the paths of work machines 110, based on the recorded estimated times, including the received estimated entry times and estimated exit times. In other words, management system 130 may estimate, for each work machine 110, the future travel time required for that work machine 110 to complete its assigned task, based on the estimated entry and/or exit times of one or more intersections 320 along the path of that work machine 110, the estimated time of arrival of that work machine 110 at one or more other landmarks, a current speed of work machine 110, the remaining distance from that work machine 110 to the destination of the path of that work machine 110, the machine profile of work machine 110, the geometry of road(s) 310 on the remaining portion of the path (e.g., uphill vs. downhill, straight vs. curved, etc.), the state of work machine 110 (e.g., with or without payload), the presence of any obstacles, and/or the like.

In subprocess 555, traffic on the worksite may be optimized based on the travel times of the work machines 110 that were estimated in subprocess 550. In particular, management system 130 may execute an optimization model that utilizes the estimated travel times as an input. The optimization model may optimize the travel times, task assignments, the respective speeds of work machines 110, the paths of work machines 110, and/or the like. The optimization model may comprise a machine-learning algorithm that minimizes or maximizes an objective function representing a target to be optimized (e.g., minimize a total travel time, maximize a total value, minimize a total cost, etc.). The output of optimization model may be new or updated tasks and/or paths that may be sent by management system 110 to one or more work machines 110, to thereby optimize traffic within the worksite, for example, to achieve target travel times for work machines 110. In other words, the traffic may be optimized by adjusting one or more paths of work machine(s) 110, adjusting one or more tasks of work machine(s) 110, adjusting the speed of one or more work machines 110, stopping one or more work machines 110, reassigning one or more work machines 110, and/or the like.

Embodiments have been primarily described herein using a central management system 130, for example, as the external system from which permissions to cross intersections 320 are received by work machines 110. However, in an alternative embodiment, the external system may be another work machine 110. In this case, obtaining permission from the external system, for example, in subprocess 455, may comprise negotiating permission with the other work machine 110. In particular, autonomous work machines 110 may implement peer-to-peer communications that enable each work machine 110 to communicate with any other work machine 110 within a certain range (e.g., 10 meters, 50 meters, 100 meters, 500 meters, etc.). Thus, each work machine 110 may send estimated entry and/or exit times to other work machines 110 within range, and, if a conflict exists, the work machines 110, involved in the conflict, may negotiate permissions using peer-to-peer communications. Such negotiation can be performed in the absence of any management system 130 or in the event that management system 130 becomes unavailable (e.g., due to failure of management system 130, network 120A, or the like).

### Industrial Applicability

Traditionally, a management system, which grants permissions to autonomous work machines for negotiating intersections, will grant permissions in the order in which they are requested. However, this technique can often result in slowdowns and other inefficiencies in operations at the worksite.

Accordingly, in disclosed embodiments, work machines 110 estimate entry and exit times for upcoming intersections 320 along their paths, and send these estimated entry and exit times to an external system, such as management system 130, which may determine whether or not a conflict exists in an intersection 320. If a conflict exists, the external system may prioritize the work machines 110, involved in the conflict, and send permissions according to the determined priorities, thereby providing more efficient intersection negotiation that can be optimized so as to minimize the consumption of fuel or battery charge.

Each work machine 110 may wait for permission to enter any intersection 320. In an embodiment, a work machine 110, which does not expect to receive permission before reaching an intersection 320, may reduce its speed well in advance of the intersection 320, in order to avoid having to stop at the intersection 320. This may eliminate or otherwise reduce the consumption of fuel or battery charge by the deceleration to a full stop, the waiting while stopped, and the acceleration from a full stop, by work machine 110.

In an embodiment, the external system may be a management system 130 that determines whether conflicts exist based on the estimated entry and exit times. When a conflict exists, management system 130 may prioritize the work machines involved in the conflict based on one or more factors. Then, the management system 130 grants permissions according to the determined priorities, to thereby optimize the negotiation of intersections within the worksite.

In addition, management system 130 may utilize the estimated times to estimate travel times for the remaining portions of the paths of work machines 110. Management system 130 may utilize the estimated travel times to optimize traffic within the worksite, thereby improving production efficiency and further reducing fuel or battery consumption by work machines 110.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of machine. Hence, although the present embodiments are, for convenience of explanation, depicted and described as being implemented in a work machine, it will be appreciated that it can be implemented in various other types of mobile equipment, and in various other systems and environments. Furthermore, there is no intention to be bound by any theory presented in any preceding section. It is also understood that the illustrations may include exaggerated dimensions and graphical representation to better illustrate the referenced items shown, and are not considered limiting unless expressly stated as such.

What is claimed is:

1. A method comprising, by a controller of a mobile work machine:
receiving one or more intersection locations, wherein each of the one or more intersection locations indicates a location of an intersection of two or more roads in a worksite;
determining that one of the one or more intersection locations is upcoming along a path of the work machine;
estimating an entry time at which the work machine will enter the intersection whose location is indicated by the one intersection location;
estimating an exit time at which the work machine will exit the intersection whose location is indicated by the one intersection location;
sending the estimated entry time and the estimated exit time to an external system via a wireless network; and
controlling the work machine to not enter the intersection, whose location is indicated by the one intersection location, until after permission is obtained from the external system.

2. The method of claim 1, wherein controlling the work machine comprises reducing a speed of the work machine.

3. The method of claim 1, wherein controlling the work machine comprises stopping the work machine.

4. The method of claim 1, wherein the worksite is a mining site.

5. The method of claim 1, wherein the one or more intersection locations are a plurality of intersection locations.

6. The method of claim 1, wherein the external system is another work machine, and wherein obtaining permission from the external system comprises negotiating permission with the other work machine.

7. The method of claim 1, wherein the external system is a management system, and wherein obtaining permission from the external system comprises receiving permission from the management system.

8. The method of claim 7, wherein the method further comprises, by at least one processor of the management system:
receiving estimated entry times and estimated exit times from a plurality of work machines for at least one intersection;
determining whether a conflict exists between two or more of the plurality of work machines based on the received estimated entry times and estimated exit times, wherein a conflict exists when the two or more work machines are estimated to be in the at least one intersection at a same time;
when no conflict exists, sending permission to each of the two or more work machines; and
when the conflict exists,
determining priorities for the two or more work machines, and
sending permission to each of the two or more work machines according to the determined priorities.

9. The method of claim 8, wherein determining priorities for the two or more work machines comprises:
calculating a value of a task to which each of the two or more work machines is assigned, based on one or more parameters; and
prioritizing the two or more work machines, relative to each other, based on the calculated values.

10. The method of claim 9, wherein the one or more parameters comprise, for each of the two or more work machines, at least one of a cost of a destination of the path of the work machine, an estimated arrival time of the work machine at the destination of the path, an indication of whether or not the work machine is hauling a load, an estimated time duration that the work machine will have to wait to enter the at least one intersection, or a fuel or energy level of the work machine.

11. The method of claim 8, wherein sending permission to each of the two or more work machines according to the determined priorities comprises, until all of the two or more work machines have been sent permissions, performing an iteration of:
sending permission to one of the two or more work machines having a highest priority and which has not yet been sent permission; and
when another of the two or more work machines remains to receive permission, waiting until the one work machine has cleared the at least one intersection before sending another permission.

12. The method of claim 7, wherein the method further comprises, by at least one processor of the management system:
receiving estimated entry times and estimated exit times from a plurality of work machines for a plurality of intersections;
estimating travel times for remaining portions of the paths of the plurality of work machines based on the received estimated entry times and estimated exit times; and
optimizing traffic within the worksite based on the estimated travel times.

13. The method of claim 12, wherein optimizing traffic comprises adjusting one or more of the paths of the plurality of work machines.

14. The method of claim 12, wherein optimizing traffic comprises adjusting one or more tasks of the plurality of work machines.

15. A work machine comprising:
a machine body;
one or more ground-engaging members configured to move the machine body with respect to a ground; and
a controller configured to
receive one or more intersection locations, wherein each of the one or more intersection locations indicates a location of an intersection of two or more roads in a worksite,
determine that one of the one or more intersection locations is on a path of the work machine,
estimate an entry time at which the work machine will enter the intersection whose location is indicated by the one intersection location,
estimate an exit time at which the work machine will exit the intersection whose location is indicated by the one intersection location,
send the estimated entry time and the estimated exit time to an external system via a wireless network, and
control the work machine to not enter the intersection, whose location is indicated by the one intersection location, until after permission is obtained from the external system.

16. A method comprising, by at least one processor of a management system:
receiving estimated entry times and estimated exit times from a plurality of work machines for at least one intersection;
determining whether a conflict exists between two or more of the plurality of work machines based on the received estimated entry times and estimated exit times, wherein a conflict exists when the two or more work machines are estimated to be in the at least one intersection at a same time;
when no conflict exists, sending permission to each of the two or more work machines; and
when the conflict exists,
determining priorities for the two or more work machines, and
sending permission to each of the two or more work machines according to the determined priorities.

17. The method of claim 16, wherein determining priorities for the two or more work machines comprises:
calculating a value of a task to which each of the two or more work machines is assigned, based on one or more parameters; and
prioritizing the two or more work machines, relative to each other, based on the calculated values.

18. The method of claim 17, wherein the one or more parameters comprise, for each of the two or more work machines, at least one of a cost of a destination of a path of the work machine, an estimated arrival time of the work machine at the destination of the path, an indication of whether or not the work machine is hauling a load, an estimated time duration that the work machine will have to wait to enter the at least one intersection, or a fuel or energy level of the work machine.

19. The method of claim 16, wherein sending permission to each of the two or more work machines according to the determined priorities comprises, until all of the two or more work machines have been given permissions, performing an iteration of:
sending permission to one of the two or more work machines having a highest priority and which has not yet received permission; and
when another of the two or more work machines remains to receive permission, waiting until the one work machine has cleared the at least one intersection before sending another permission.

20. The method of claim 16, wherein the method further comprises, by the at least one processor of the management system:
estimating travel times for remaining portions of paths of the plurality of work machines based on the received estimated entry times and estimated exit times; and
optimizing traffic within the worksite based on the estimated travel times.
